(19) United States
(12) Patent Application Publication
(10) Pub. No.: US 2025/0206867 A1
(43) Pub. Date: Jun. 26, 2025

(54) RESIN COMPOSITION, ELECTRONIC DEVICE, AND METHOD OFMANUFACTURING THE ELECTRONIC DEVICE

(71) Applicant: Samsung Display Co., LTD., Yongin-si (KR)

(72) Inventor: SU-HYOUNG KANG, Yongin-si (KR)

(21) Appl. No.: 18/957,816

(22) Filed: Nov. 24, 2024

(30) Foreign Application Priority Data
Dec. 26, 2023 (KR) 10-2023-0191072

(51) Int. Cl. C08F 259/08; B05D 7/00; C08F 2/50; C09D 4/06; C09D 151/00

(52) U.S. Cl. CPC C08F 259/08; B05D 7/546; C08F 2/50; C09D 4/06; C09D 151/003; B05D 2210/00; B05D 2400/00; B05D 2401/31; B05D 2420/01; B05D 2420/02; B05D 2502/005; B05D 2506/10

(57) ABSTRACT

A resin composition includes a polymer resin, a fluoride resin, and a radical polymerization initiator, where the polymer resin includes at least one selected from an epoxy siloxane-based compound, a (meth)acrylate monomer, and a tetrahydrofurfuryl acrylic acid.

This application claims priority to Korean Patent Application No. 10-2023-0191072, filed on Dec. 26, 2023, and all the benefits accruing therefrom under 35 U.S.C. § 119, the content of which in its entirety is herein incorporated by reference.

### BACKGROUND

### 1. Field

The disclosure relates to a resin composition, an electronic device including a coating layer including the resin composition, and a method of manufacturing the electronic device.

### 2. Description of Related Art

Various display devices applied to multimedia devices, such as televisions, mobile phones, tablet computers, navigation units, and game units, are being developed. A display device typically includes various components, and a window of the display device that protects a display module of the display device from external impacts may be formed by a direct coating method.

### SUMMARY

When a window of a display device is formed by a direct coating method, the window may include a polymer compound. The physical properties of the polymer compound may be impaired by moisture in high-temperature and high-humidity environments. Accordingly, materials with waterproof properties are desired to be used a the polymer compound.

The disclosure provides a resin composition capable of preventing physical properties of a coating layer formed thereof from being impaired due to moisture in high-temperature and high-humidity environments and preventing physical properties of the coating layer from being impaired by reducing generation of hydrogen ions during a polymer polymerization process.

The disclosure provides an electronic device including the coating layer formed of the resin composition.

The disclosure provides a method of manufacturing the electronic device.

Embodiments of the invention provide a resin composition including a polymer resin, a fluoride resin, and a radical polymerization initiator, where the polymer resin includes at least one selected from an epoxy siloxane-based compound, a (meth)acrylate monomer, and a tetrahydrofurfuryl acrylic acid monomer.

In an embodiment, the polymer resin may be an epoxy siloxane-based resin.

In an embodiment, the fluoride resin may include at least one selected from a polytetrafluoroethylene (PTFE) monomer, a polyvinylidene fluoride (PVDF) monomer, a polyvinyl fluoride (PVF) monomer, an ethylene tetra fluoro ethylene (ETFE) monomer, a polyoxymethylene (PFA) monomer, a poly[4,5-difluoro-2,2-bis(trifluoromethyl)-1,3-dioxole-co-tetrafluoroethylene] monomer, a poly[perfluoro(butenyl vinyl ether)] monomer, a poly(tetrafluoroethylene-co-2,2,4-trifluoro-5-trifluoromethoxy-1,3-dioxole) monomer, a poly(tetrafluoroethylene-co-perfluoro-3,6-dioxa-4-methyl-7-octenesulfonic acid) monomer, a fluorinated methacrylate, a fluorinated styrene, a fluorinated vinylether, a fluorinated silicon, a fluorinated imide, a fluorinated diphthalic anhydride, and a fluorinated oxetane.

In an embodiment, a weight of the fluoride resin, relative to a total weight of the resin composition, may be equal to or greater than about 10 weight percent (wt. %) and equal to or less than about 20 wt. %.

In an embodiment, the radical polymerization initiator may include at least one selected from an acetophenone-based initiator, a sulfonium salt-based initiator, and a benzophenone-based initiator.

In an embodiment, the acetophenone-based initiator may include at least one selected from benzyldimethyl ketal, 1-hydroxy-cyclohexyl phenyl ketone, and bis(2,4,6-trimethyl benzoyl)-phenyl phosphine oxide.

In an embodiment, a weight of the radical polymerization initiator, relative to a total weight of the resin composition, may be equal to or greater than about 1 wt. % and equal to or less than about 5 wt. %.

In an embodiment, the resin composition may further include a framework compound, a cross-linking agent, and a diluent. In such an embodiment, the framework compound includes at least one selected from a polyester acrylate oligomer, an epoxy acrylate oligomer, a urethane acrylate oligomer, and a polyethylene glycol acrylate oligomer, and the cross-link agent may include at least one selected from tripropylene glycol diacrylate (TPGDA), hexanediol diacrylate (HDDA), dodecanedioic acid (DDDA), and bisphenol A(ethoxylate)ₓdiacrylate (BPA(EO)ₓDA), where x is an integer equal to or greater than 3 and equal to or less than 30.

In an embodiment, the diluent may include at least one selected from a polyester acrylate oligomer and a polyether acrylate oligomer.

In an embodiment, a viscosity of the resin composition at 25° C., which is measured by JIS K7117-2, may be equal to or greater than about 1 cP and equal to or less than about 1000 cP.

Embodiments of the invention provide an electronic device including a housing, a display panel disposed in the housing, and a first coating layer disposed on the display panel. In such embodiments, the first coating layer includes a resin composition including a polymer resin, a fluoride resin, and a radical polymerization initiator, where the polymer resin includes at least one selected from an epoxy siloxane-based compound, a (meth)acrylate monomer, and a tetrahydrofurfuryl acrylic acid monomer.

In an embodiment, the first coating layer may have a thickness equal to or greater than about 100 micrometers and equal to or less than about 300 micrometers.

In an embodiment, the electronic device may further include a second coating layer disposed on the first coating layer.

In an embodiment, the second coating layer may have a hardness greater than a hardness of the first coating layer.

In an embodiment, the second coating layer may have a thickness equal to or greater than about 10 micrometers and equal to or less than about 15 micrometers.

In an embodiment, the electronic device may further include a polarizing plate disposed between the display panel and the first coating layer.

In an embodiment, the electronic device may further include a polarizing plate disposed on the first coating layer.

Embodiments of the invention provide a method of manufacturing an electronic device. In such embodiments, the method includes forming a resin composition including a polymer resin, a fluoride resin, and a radical polymerization initiator, where the polymer resin includes at least one selected from an epoxy siloxane-based compound, a (meth)acrylate monomer, and a tetrahydrofurfuryl acrylic acid monomer, spraying the resin composition on a base substrate to form a preliminary first coating layer, and radiating an ultraviolet ray to the preliminary first coating layer to form a first coating layer.

In an embodiment, the fluoride resin may include at least one selected from a polytetrafluoroethylene (PTFE) monomer, a polyvinylidene fluoride (PVDF) monomer, a polyvinyl fluoride (PVF) monomer, an ethylene tetra fluoro ethylene (ETFE) monomer, a polyoxymethylene (PFA) monomer, a poly[4,5-difluoro-2,2-bis(trifluoromethyl)-1,3-dioxole-co-tetrafluoroethylene] monomer, a poly[perfluoro(butenyl vinyl ether)] monomer, a poly(tetrafluoroethylene-co-2,2,4-trifluoro-5-trifluoromethoxy-1,3-dioxole) monomer, a poly(tetrafluoroethylene-co-perfluoro-3,6-dioxa-4-methyl-7-octenesulfonic acid) monomer, a fluorinated methacrylate, a fluorinated styrene, a fluorinated vinylether, a fluorinated silicon, a fluorinated imide, a fluorinated diphthalic anhydride, and a fluorinated oxetane, and a weight of the fluoride resin, relative to a total weight of the resin composition, may be equal to or greater than about 10 wt. % and equal to or less than about 20 wt. %.

In an embodiment, the radical polymerization initiator may include at least one selected from an acetophenone-based initiator, a sulfonium salt-based initiator, and a benzophenone-based initiator, and a weight of the radical polymerization initiator, relative to a total weight of the resin composition, may be equal to or greater than about 1 wt. % and equal to or less than about 5 wt. %.

According to embodiments, the deterioration of physical properties of the first coating layer including or formed of the resin composition caused by high-temperature and high-humidity environments is minimized.

According to embodiments of the manufacturing method of the electronic device, the deterioration of the physical properties of the first coating layer formed of the resin composition caused by high-temperature and high-humidity environments is minimized, and thus, the display module is effectively protected from external impacts.

### BRIEF DESCRIPTION OF THE DRAWINGS

The above and other features of embodiments of the disclosure will become readily apparent by reference to the following detailed description when considered in conjunction with the accompanying drawings, in which:

FIG. 1 is a perspective view of an electronic device according to an embodiment of the disclosure;

FIG. 2 is an exploded perspective view of an electronic device according to an embodiment of the disclosure;

FIG. 3 is a cross-sectional view taken along line I-I′ of FIG. 1;

FIG. 4 is a perspective view of an electronic device according to an embodiment of the disclosure;

FIG. 5 is a cross-sectional view taken along line II-II′ of FIG. 4;

FIG. 6 is a flowchart illustrating an embodiment of a method of manufacturing an electronic device; and

FIGS. 7 to 10 are cross-sectional views illustrating processes of a method of manufacturing an electronic device according to an embodiment of the disclosure.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art.

In the disclosure, it will be understood that when an element (or area, layer, or portion) is referred to as being “on”, “connected to” or “coupled to” another element or layer, it can be directly on, connected or coupled to the other element or layer or intervening elements or layers may be present.

Like numerals refer to like elements throughout. In the drawings, the thickness, ratio, and dimension of components are exaggerated for effective description of the technical content.

It will be understood that, although the terms first, second, etc. may be used herein to describe various elements, these elements should not be limited by these terms. These terms are only used to distinguish one element from another element. Thus, a first element discussed below could be termed a second element without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

It will be further understood that the terms “comprises” and/or “comprising,” or “include” and/or “including”, when used in this specification, specify the presence of stated features, integers, steps, operations, elements, and/or components, but do not preclude the presence or addition of one or more other features, integers, steps, operations, elements, components, and/or groups thereof.

In the following descriptions, the expression that “Component A is directly disposed/provided on component B” means that no intervening elements are present between component A and component B. That is, the expression that “Component A is directly disposed/provided on component B” means that component A is in contact with component B.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations. or within ±30%, 20%, 10% or 5% of the stated value.

Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the disclosure will be described with reference to the accompanying drawings.

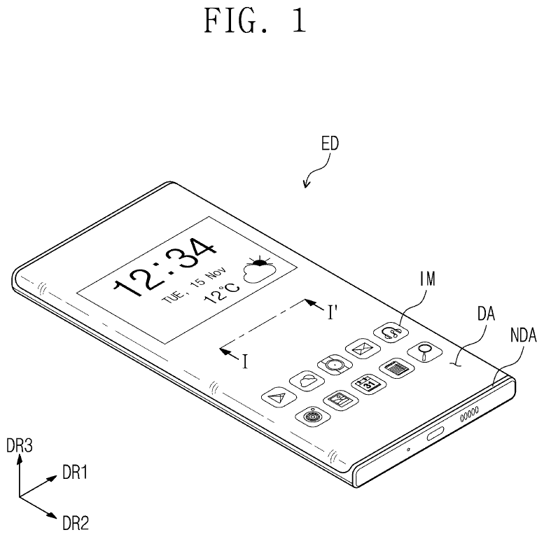

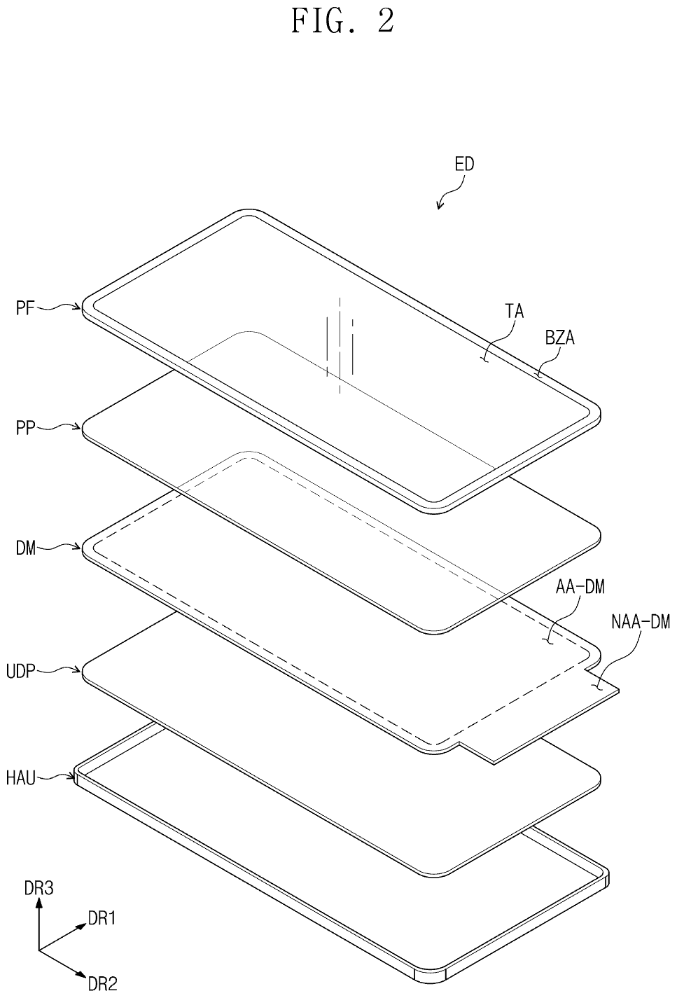

FIG. 1 is a perspective view of an electronic device ED according to an embodiment of the disclosure. FIG. 2 is an exploded perspective view of the electronic device ED according to an embodiment of the disclosure.

Referring to FIG. 1, an embodiment of the electronic device ED may be activated in response to electrical signals. In an embodiment, for example, the electronic device ED may be a personal computer, a notebook computer, a personal digital assistant, a game unit, a mobile electronic device, a television, a monitor, an outdoor billboard, a car navigation unit, or a wearable device, however, it should not be limited thereto or thereby. FIG. 1 shows an embodiment where the electronic device ED is a mobile phone as a representative example.

The electronic device ED may display an image IM through a display area DA. The display area DA may include a plane defined by a first directional axis DR1 and a second directional axis DR2. The display area DA may further include a curved surface bent from at least one side of the plane defined by the first directional axis DR1 and the second directional axis DR2. In an embodiment, as shown in FIG. 1, the electronic device ED may include two curved surfaces respectively bent from two sides of the plane defined by the first directional axis DR1 and the second directional axis DR2, however, it should not be limited thereto or thereby. In another embodiment, for example, the display area DA may include only the plane defined by the first directional axis DR1 and the second directional axis DR2, or the display area DA may further include two or more curved surfaces, e.g., four curved surfaces respectively bent from four sides of the plane defined by the first directional axis DR1 and the second directional axis DR2.

The electronic device ED of the disclosure may be flexible. The term “flexible” used herein refers to the property of being able to be bent from a structure that is completely bent to a structure that is bent at the scale of a few nanometers. In an embodiment, for example, the electronic device ED may be a curved display device or a foldable display device. According to an embodiment, the electronic device ED may be rigid.

A non-display area NDA may be defined adjacent to the display area DA. The non-display area NDA may surround the display area DA. Accordingly, the display area DA may have a shape that is substantially defined by the non-display area NDA, however, this is merely an example. The non-display area NDA may be defined adjacent to only one side of the display area DA or may be omitted. According to an embodiment, the display area DA may be provided in various shapes, and it should not be particularly limited.

FIG. 1 and the following drawings show first, second, and third directional axes DR1, DR2, and DR3, and directions indicated by the first, second, and third directional axes DR1, DR2, and DR3 may be relative to each other and may be changed in other directions. In addition, the directions indicated by the first, second, and third directional axes DR1, DR2, and DR3 may be referred to as first, second, and third directions, respectively, and the first, second, and third directions may be assigned with the same reference numerals as those of the first, second, and third directional axes DR1, DR2, and DR3. In the following descriptions, the first directional axis DR1 may be substantially perpendicular to the second directional axis DR2, and the third directional axis DR3 may be a normal line direction with respect to the plane defined by the first directional axis DR1 and the second directional axis DR2.

A thickness direction of the electronic device ED may be substantially parallel to the third directional axis DR3 that is the normal line direction of the plane defined by the first directional axis DR1 and the second directional axis DR2. In an embodiment, a front surface (or an upper surface, an upper portion surface, or an upper side) and a rear surface (or a lower surface, a lower portion surface, or a lower side) of each member of the electronic device ED may be defined with respect to the third directional axis DR3. In addition, a direction to which the third directional axis DR3 extends may be substantially parallel to the thickness direction, the front surface (or the upper surface, the upper portion surface, or the upper side) may indicate a surface (or a direction) adjacent to a surface through which the image IM is displayed, and the rear surface (or the lower surface, the lower portion surface, or the lower side) may indicate a surface (or a direction) spaced apart from the surface through which the image IM is displayed. In the disclosure, the term “plane” means a surface substantially parallel to the plane defined by the first directional axis DR1 and the second directional axis DR2, and the term “cross-section” means a surface perpendicular to the plane defined by the first directional axis DR1 and the second directional axis DR2 and substantially parallel to the thickness direction DR3.

Referring to FIG. 2, an embodiment of the electronic device ED may include a housing HAU, a display module DM, and a protective film PF disposed on the display module DM. In addition, the electronic device ED may further include a lower panel UDP disposed between the housing HAU and the display module DM and a polarizing plate PP disposed between the display module DM and the protective film PF.

In an embodiment of the electronic device ED, as shown in FIGS. 1 and 2, the protective film PF and the housing HAU may be coupled to each other to provide an exterior of the electronic device ED. The housing HAU may be disposed under the display module DM.

The housing HAU may include a material with a relatively high rigidity. In an embodiment, for example, the housing HAU may include a plurality of frames and/or plates including or formed of a glass, plastic, or metal material. The housing HAU may provide a predetermined accommodation space. The display module DM may be accommodated in the accommodation space and may be protected from external impacts.

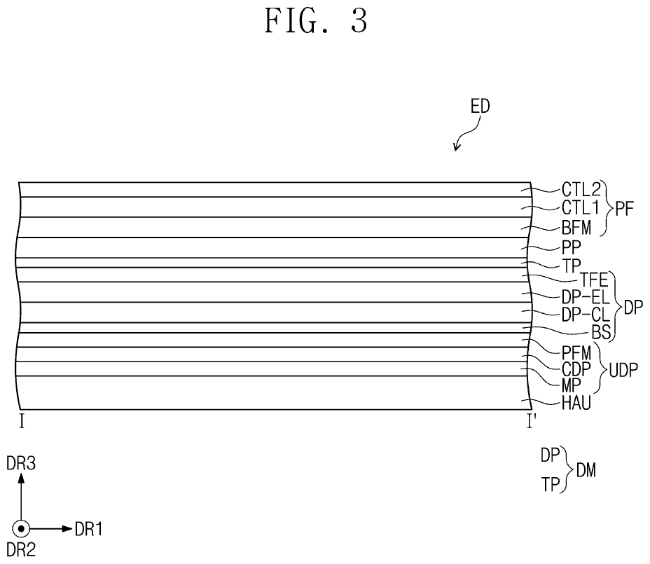

The lower panel UDP may be disposed between the housing HAU and the display module DM. The lower panel UDP may be disposed directly on a lower surface of the display module DM. The lower panel UDP may disperse an external impact applied to the display module DM and thus may protect the display module DM. The lower panel UDP will be described in detail later with reference to FIG. 3.

The protective film PF may include a transmissive area TA and a bezel area BZA. The transmissive area TA may overlap at least a portion of an active area AA-DM of the display module DM. The transmissive area TA may be an optically transparent area. The image IM may be provided to a user through the transmissive area TA. The protective film PF will be described in detail later with reference to FIG. 3.

The bezel area BZA may be an area having a relatively lower transmittance than that of the transmissive area TA. The bezel area BZA may define a shape of the transmissive area TA. The bezel area BZA may be disposed adjacent to the transmissive area TA and may surround the transmissive area TA.

The bezel area BZA may have a predetermined color. The bezel area BZA may cover a peripheral area NAA-DM of the display module DM to prevent the peripheral area NAA-DM from being viewed from the outside, however, this is merely an example. The bezel area BZA may be disposed adjacent to only one side of the transmissive area TA or at least a portion thereof may be omitted.

FIG. 3 is a cross-sectional view taken along line I-I′ of FIG. 1. FIG. 3 shows the cross-section of the lower panel UDP, the display module DM, the polarizing plate PP, and the protective film PF of FIG. 2. In addition, FIG. 3 is a cross-sectional view of the electronic device ED.

Referring to FIG. 3, in an embodiment of the electronic device ED, the lower panel UDP may include a metal plate MP disposed on the housing HAU, a cover plate CDP disposed on the metal plate MP, and a lower protective film PFM disposed on the cover plate CDP.

The metal plate MP may be disposed between the housing HAU and the cover panel CDP. The metal plate MP may be disposed directly on the housing HAU. The metal plate MP may support a display panel DP. The metal plate MP may include a metal material. In an embodiment, for example, the metal plate MP may include a stainless steel material. The metal plate MP may have a thickness equal to or greater than about 100 micrometers and equal to or less than about 500 micrometers.

The cover plate CDP may be disposed between the metal plate MP and the lower protective film PFM. The cover plate CDP may increase a resistance to a compressive force caused by an external pressure. Accordingly, the cover plate CDP may effectively prevent the display panel DP from being deformed. The cover plate CDP may include a plastic material such as polyimide or polyethylene terephthalate. The cover plate CDP may have a thickness equal to or greater than about 10 micrometers and equal to or less than about 100 micrometers.

The lower protective film PFM may be disposed under the display panel DP. The lower protective film PFM may protect a lower portion of the display panel DP. The lower protective film PFM may include a flexible plastic material. In an embodiment, for example, the lower protective film PFM may include polyethylene terephthalate (PET). The lower protective film PFM may have a thickness equal to or greater than about 10 micrometers and equal to or less than about 100 micrometers. The thickness of the metal plate MP may be greater than the thickness of each of the cover plate CDP and the lower protective film PFM. The thickness of the lower protective film PFM may be greater than the thickness of the cover plate CDP.

The display module DM may include the display panel DP and an input sensing unit TP disposed on the display panel DP. The display panel DP may have a configuration that substantially generates images. The display panel DP may include a base substrate BS, a circuit layer DP-CL disposed on the base substrate BS, a display element layer DP-EL disposed on the circuit layer DP-CL, and an encapsulation layer TFE that covers the display element layer DP-EL.

The structure of the display panel DP shown in FIG. 3 is merely an example, and the structure of the display panel DP should not be limited thereto or thereby. In another embodiment, for example, the display panel DP may include a liquid crystal display element, and in such an embodiment, the encapsulation layer TFE may be omitted.

The base substrate BS may provide a base surface on which the circuit layer DP-CL is disposed. The base substrate BS may be a flexible substrate that is bendable, foldable, or rollable. The base substrate BS may be a glass substrate, a metal substrate, or a polymer substrate. However, the embodiment should not be limited thereto or thereby, and the base substrate BS may be an inorganic layer, an organic layer, or a composite material layer.

The circuit layer DP-CL may include an insulating layer, a semiconductor pattern, a conductive pattern, and a signal line. In an embodiment, for example, the circuit layer DP-CL may include a switching transistor and a driving transistor to drive a light emitting element (not shown) of the display element layer DP-EL describe later.

The display element layer DP-EL may include the light emitting element emitting a light. In an embodiment, for example, the light emitting element may include an organic light emitting material, an inorganic light emitting material, an organic-inorganic light emitting material, a quantum dot, a quantum rod, a micro-light emitting diode (LED), or a nano-LED.

The encapsulation layer TFE may be disposed on the display element layer DP-EL. The encapsulation layer TFE may protect the display element layer DP-EL from moisture, oxygen, and/or a foreign substance such as dust particles. The encapsulation layer TFE may include at least one inorganic layer. In an embodiment, for example, the encapsulation layer TFE may include an inorganic layer, an organic layer, and an inorganic layer, which are sequentially stacked.

The input sensing unit TP may be disposed on the display panel DP. In an embodiment, for example, the input sensing unit TP may be disposed directly on the encapsulation layer TFE. According to an embodiment, an adhesive layer may be disposed between the input sensing unit TP and the display panel DP.

The input sensing unit TP may sense an external input, may convert the external input to a predetermined input signal, and may provide the input signal to the display panel DP. In an embodiment, for example, the input sensing unit TP of the electronic device ED may be a touch sensing unit that senses a touch event. The input sensing unit TP may sense a direct touch of a user, an indirect touch of the user, a direct touch of an object, or an indirect touch of the object.

The input sensing unit TP may sense at least one selected from a position of the touch event applied from the outside of the input sensing unit TP and an intensity (pressure) of the touch event applied from the outside of the input sensing unit TP. The input sensing unit TP may have various structures or may include various materials, and it should not be particularly limited. The input sensing unit TP may sense the external input in a capacitive method. The display panel DP may receive the input signal from the input sensing unit TP and may generate an image corresponding to the input signal.

The polarizing plate PP may prevent external light from being reflected. The polarizing plate PP may block a portion of the external light. The polarizing plate PP may have an anti-reflective function to reduce the reflection of the external light in the electronic device ED. In an embodiment, the polarizing plate PP may be formed by allowing dichroic dye to be adsorbed onto a stretched polymer film. In an embodiment, for example, the polarizing plate PP may be formed by allowing iodine to be adsorbed onto a stretched polyvinylalcohol film. In such an embodiment, a direction in which the polymer film is stretched may be an adsorption axis of the polarizing plate PP, and a direction substantially perpendicular to the stretched direction may be a transmission axis of the polarizing plate PP.

In an embodiment, although not shown in figures, the polarizing plate PP may further include at least one protective layer. In an embodiment, for example, the polarizing plate PP may further include a triacetyl cellulose (TAC) layer disposed on at least one selected from upper and lower surfaces thereof. However, the disclosure should not be limited thereto or thereby, and the polarizing plate PP may further include a hard coating layer, an anti-reflective layer, or an anti-glare layer as the protective layer.

The protective film PF may include a base film BFM disposed on the polarizing plate PP, a first coating layer CTL1 disposed on the base film BFM, and a second coating layer CTL2 disposed on the first coating layer CTL1.

The base film BFM may provide a base surface on which the first coating layer CTL1 is disposed. The base film BFM may be a flexible substrate that is bendable, foldable, or rollable. The base film BFM may be a glass substrate, a metal substrate, or a polymer substrate. In an embodiment, for example, the base film BFM may include polyethylene terephthalate.

The first coating layer CTL1 may protect the display module DM from the external impact. The first coating layer CTL1 may be disposed directly on the base film BFM. An adhesive layer may not be disposed between the first coating layer CTL1 and the base film BFM. The first coating layer CTL1 may have a thickness equal to or greater than about 100 micrometers and equal to or less than about 300 micrometers. When the thickness of the first coating layer CTL1 is less than about 100 micrometers, an absorbing function of the protective film PF with respect to the external impact may be deteriorated. When the thickness of the first coating layer CTL1 is greater than about 300 micrometers, a visibility of the electronic device ED may be lowered.

The first coating layer CTL1 may include a polymer resin, a fluoride resin, and a radical polymerization initiator. The first coating layer CTL1 may be formed from or using a resin composition including the polymer resin, the fluoride resin, and the radical polymerization initiator.

The polymer resin of the first coating layer CTL1 may act as a main binder when the first coating layer CTL1 is formed. The polymer resin of the first coating layer CTL1 may include at least one selected from an epoxy siloxane-based compound, a (meth)acrylate monomer, and a tetrahydrofurfuryl acrylic acid monomer. The polymer resin may be an epoxy siloxane-based resin.

The fluoride resin of the first coating layer CTL1 may increase durability and reliability of the first coating layer CTL1. That is, the fluoride resin of the first coating layer CTL1 may provide waterproof properties to the first coating layer CTL1.

The fluoride resin may include a monomer including fluorine groups in the molecular structure thereof. The fluoride resin of the first coating layer CTL1 may include at least one selected from a polytetrafluoroethylene (PTFE) monomer, a polyvinylidene fluoride (PVDF) monomer, a polyvinyl fluoride (PVF) monomer, an ethylene tetra fluoro ethylene (ETFE) monomer, a polyoxymethylene (PFA) monomer, a poly[4,5-difluoro-2,2-bis(trifluoromethyl)-1,3-dioxole-co-tetrafluoroethylene] monomer, a poly[perfluoro (butenyl vinyl ether)] monomer, a poly(tetrafluoroethylene-co-2,2,4-trifluoro-5-trifluoromethoxy-1,3-dioxole) monomer, a poly(tetrafluoroethylene-co-perfluoro-3,6-dioxa-4-methyl-7-octenesulfonic acid) monomer, a fluorinated methacrylate, a fluorinated styrene, a fluorinated vinylether, a fluorinated silicon, a fluorinated imide, a fluorinated diphthalic anhydride, and a fluorinated oxetane.

The radical polymerization initiator of the first coating layer CTL1 may act as an initiator of a polymer polymerization reaction. Unlike a cationic polymerization initiator that generates a hydrogen ion during a polymerization initiation process, the radical polymerization initiator of the first coating layer CTL1 may not generate the hydrogen ion during the polymerization initiation process and may generate a radical to uniformly maintain pH (hydrogen ion exponent) in polymerization environment. Accordingly, the radical polymerization initiator of the first coating layer CTL1 may provide a stable initiation of the polymer polymerization compared to the cationic polymerization initiator. The radical polymerization initiator of the first coating layer CTL1 may include at least one selected from an acetophenone-based initiator, a sulfonium salt-based initiator, and a benzophenone-based initiator. The acetophenone-based initiator may include at least one selected from benzyldimethyl ketal, 1-hydroxy-cyclohexyl phenyl ketone, and bis(2,4,6-trimethyl benzoyl)-phenyl phosphine oxide.

The first coating layer CTL1 may further include a framework compound, a cross-linking agent, and a diluent.

The framework compound of the first coating layer CTL1 may improve a durability of the first coating layer CTL1. The framework compound of the first coating layer CTL1 may include at least one selected from a polyester acrylate oligomer, an epoxy acrylate oligomer, a urethane acrylate oligomer, and a polyethylene glycol acrylate oligomer.

The cross-link agent of the first coating layer CTL1 may chemically connect the framework compounds of the first coating layer CTL1. The cross-link agent of the first coating layer CTL1 may improve the reliability and stability of the first coating layer CTL1. The cross-link agent of the first coating layer CTL1 may include at least one selected from tripropylene glycol diacrylate (TPGDA), hexanediol diacrylate (HDDA), dodecanedioic acid (DDDA), and bisphenol A(ethoxylate)ₓ diacrylate (BPA(EO)ₓ DA). Here, x is an integer equal to or greater than 3 and equal to or less than 30. In an embodiment, for example, x may be 10.

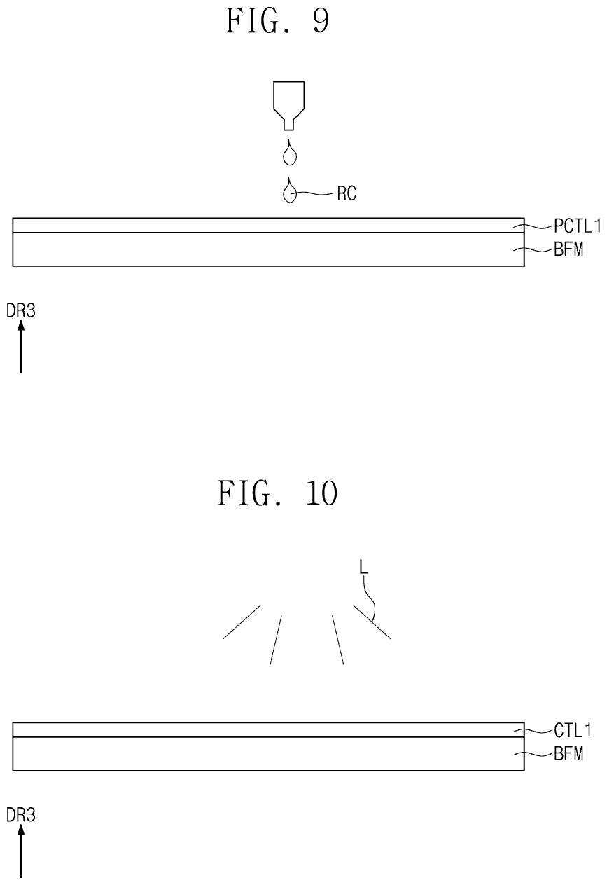

A viscosity of the first coating layer CTL1 may be controlled by the diluent of the first coating layer CTL1. The viscosity of the resin composition RC (refer to FIG. 9) forming the first coating layer CTL1 at 25° C., which is measured by JIS K7117-2 of Japanese Industrial Standard (JIS), may be equal to or greater than about 1 centipoise (cP) and equal to or less than about 1000 cP. When the viscosity of the resin composition RC (refer to FIG. 9) forming the first coating layer CTL1 is less than about 1 cP, the display module DM may be vulnerable to the external impact. When the viscosity of the resin composition RC (refer to FIG. 9) forming the first coating layer CTL1 is greater than about 1000 cP, cracks may occur in the first coating layer CTL1, and the durability of the first coating layer CTL1 may be deteriorated. The diluent of the first coating layer CTL1 may include at least one selected from a polyester acrylate oligomer and a polyether acrylate oligomer.

The second coating layer CTL2 may be disposed directly on the first coating layer CTL1. The second coating layer CTL2 may define an uppermost surface of the electronic device ED. The second coating layer CTL2 may have a hardness greater than a hardness of the first coating layer CTL1 and thus may effectively prevent scratches and cracks from occurring on an upper surface of the first coating layer CTL1. An adhesive member may not be present between the second coating layer CTL2 and the first coating layer CTL1. The second coating layer CTL2 may have a thickness equal to or greater than about 10 micrometers and equal to or less than about 15 micrometers. When the thickness of the second coating layer CTL2 is less than about 10 micrometers, the absorbing function of the protective film PF with respect to the external impact may be deteriorated. When the thickness of the second coating layer CTL2 is greater than about 15 micrometers, the visibility of the electronic device ED may be deteriorated.

In an embodiment, as described above, the electronic device ED may include the first coating layer CTL1 disposed directly on the base film BFM, and thus, an adhesive layer may not be present directly on a lower surface of the first coating layer CTL1. Accordingly, in such an embodiment, the visibility of the electronic device ED may be improved, and a total thickness of the electronic device ED may be substantially reduced. In such an embodiment, as the first coating layer CTL1 includes the fluoride resin with the waterproof properties, external moisture may be effectively prevented from entering the display module DM of the electronic device ED even though the electronic device ED is exposed to the high-temperature and high-humidity environments, and a corrosion phenomenon caused by the external moisture may be effectively prevented. In such an embodiment, as the first coating layer CTL1 includes the radical polymerization initiator, the generation of the hydrogen ions during the polymerization initiation and elongation process may be substantially reduced, and changes in physical properties of the electronic device ED may be substantially reduced.

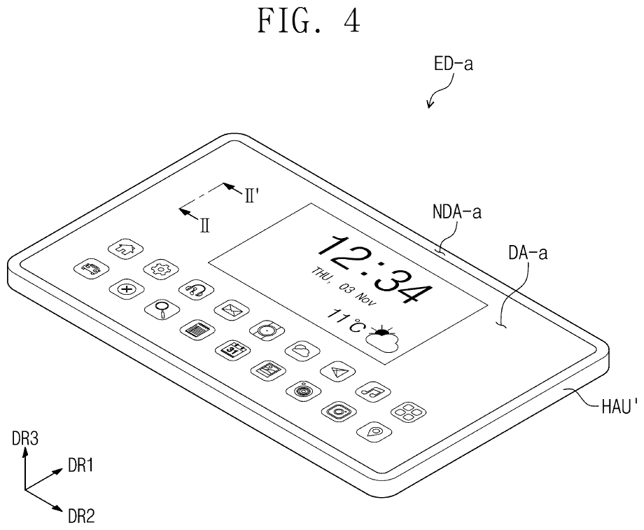

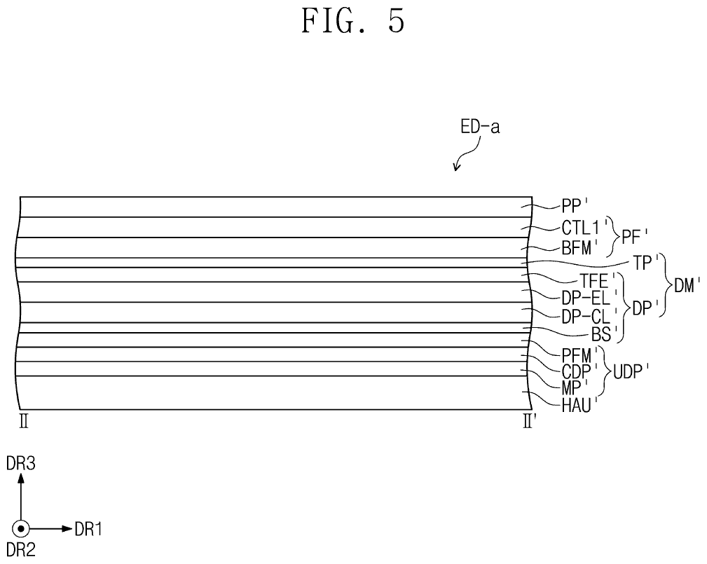

FIG. 4 is a perspective view of an electronic device ED-a according to an embodiment of the disclosure. FIG. 5 is a cross-sectional view taken along line II-II′ of FIG. 4. FIG. 4 shows an embodiment where the electronic device ED-a is a tablet terminal or tablet computer.

Referring to FIGS. 4 and 5, an embodiment of the electronic device ED-a may include a housing HAU′, a display module DM′ disposed in the housing HAU′, and a protective film PF′ disposed on the display module DM′. In such an embodiment, the housing HAU′, a display area DA-a, and a non-display area NDA-a shown in FIG. 4 may be substantially the same as the housing HAU, the display area DA, and the non-display area NDA described above with reference to FIGS. 1 and 2, and any repetitive detailed description thereof will be omitted.

In such an embodiment, the housing HAU′, a lower panel UDP′, the display module DM′, a base film BFM′, a first coating layer CTL1′, and a polarizing plate PP′ shown in FIG. 5 may be substantially the same as the housing HAU, the lower panel UDP, the display module DM, the base film BFM, the first coating layer CTL1, and the polarizing plate PP of the electronic device ED described above with reference to FIG. 3, and any repetitive detailed description thereof will be omitted.

In an embodiment, as shown in FIG. 5, the polarizing plate PP′ of the electronic device ED-a is disposed on the first coating layer CTL1′, and a component corresponding to the second coating layer CTL2 shown in FIG. 3 is omitted. That is, according to an embodiment of the electronic device ED-a, the protective film PF′ may include the base film BFM′ and the first coating layer CTL1′, the first coating layer CTL1′ may be disposed between the polarizing plate PP′ and the display module DM′, and the polarizing plate PP′ may be disposed at an uppermost position of the electronic device ED-a instead of the protective film PF′.

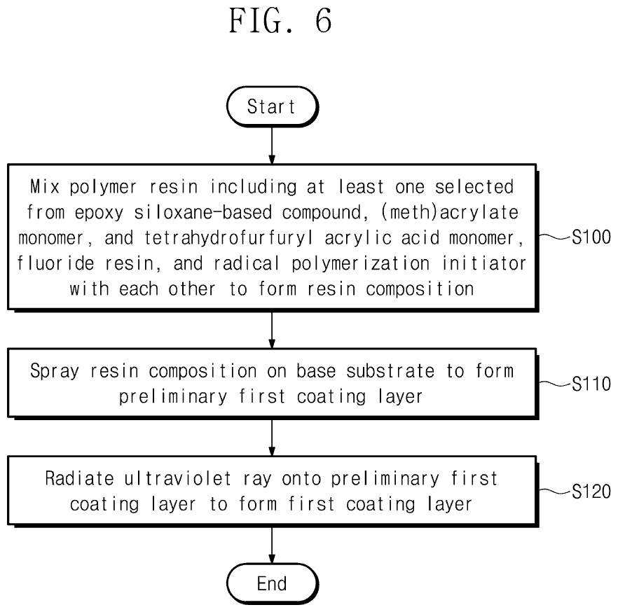

FIG. 6 is a flowchart illustrating an embodiment of a method of manufacturing the electronic device.

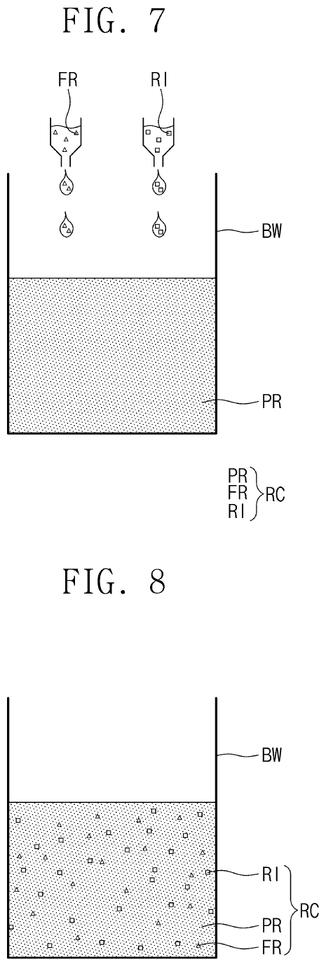

Referring to FIG. 6, an embodiment of the manufacturing method of the electronic device may include mixing the polymer resin including at least one selected from the epoxy siloxane-based compound, the (meth)acrylate monomer, and the tetrahydrofurfuryl acrylic acid monomer, the fluoride resin, and the radical polymerization initiator with each other to form the resin composition (S100), spraying the resin composition on the base substrate to form a preliminary first coating layer (S110), and radiating an ultraviolet ray onto the preliminary first coating layer to form the first coating layer (S120). Hereinafter, processes of an embodiment of the manufacturing method of the electronic device will be described in detail with reference to FIGS. 7 to 10.

FIGS. 7 to 10 are cross-sectional views illustrating the processes of the manufacturing method of the electronic device according to an embodiment of the disclosure.

Referring to FIGS. 7 and 8, the forming of the resin composition RC may include providing a mixture including the polymer resin PR to a container BW and adding a mixture including the fluoride resin FR and a mixture including the radical polymerization initiator RI into the container BW to form the resin composition RC.

The container BW may accommodate the mixture including the polymer resin PR and may include glass, metal, or polymer. In an embodiment, for example, the container BW may include or be formed of a plastic material.

The resin composition RC may include the polymer resin PR, the fluoride resin FR, and the radical polymerization initiator RI. In such an embodiment, the polymer resin PR, the fluoride resin FR, and the radical polymerization initiator RI are substantially the same as the polymer resin, the fluoride resin, and the radical polymerization initiator described above with reference to FIG. 3, and any repetitive detailed description thereof will be omitted.

In the resin composition RC, a weight of the fluoride resin FR, relative to a total weight of the resin composition RC, may be equal to or greater than about 10 weight percent (wt. %) and equal to or less than about 20 wt. %. When the weight of the fluoride resin FR is less than about 10 wt. % relative to the total weight of the resin composition RC, the waterproof properties of the first coating layer CTL1 (refer to FIG. 3) formed of the resin composition RC may be deteriorated. When the weight of the fluoride resin FR is greater than about 20 wt. % relative to the total weight of the resin composition RC, the physical properties of the resin composition RC may be deteriorated, and thus, protective characteristics of the first coating layer CTL1 (refer to FIG. 3) formed of the resin composition RC may be deteriorated.

In the resin composition RC, a weight of the radical polymerization initiator RI, relative to a total weight of the resin composition RC, may be equal to or greater than about 1 wt. % and equal to or less than about 5 wt. %. When the weight of the radical polymerization initiator RI is less than about 1 wt. % relative to the total weight of the resin composition RC, the radical may not be generated sufficient to initiate the polymer polymerization, and thus, the physical properties of the resin composition RC may be deteriorated. When the weight of the radical polymerization initiator RI is less than about 5 wt. % relative to the total weight of the resin composition RC, the radical may be excessively generated, and thus, the physical properties of the resin composition RC may be deteriorated.

FIGS. 9 and 10 show processes of forming the first coating layer CTL1 of FIG. 3. In FIGS. 9 and 10, the housing HAU, the lower panel UDP, the display module DM, and the polarizing plate PP shown in FIG. 3 are omitted for convenience of illustration and description.

Referring to FIGS. 9 and 10, the preliminary first coating layer PCTL1 may be formed by spraying the resin composition RC onto an upper surface of the base film BFM. The resin composition RC may be sprayed onto the upper surface of the base film BFM by an inkjet printing method, a dispensing method, or a jet dispensing method. However, the disclosure should not be limited thereto or thereby.

The preliminary first coating layer PCTL1 may be cured by an ultraviolet ray L, and thus, the first coating layer CTL1 may be formed. The ultraviolet ray L may be radiated at an intensity equal to or greater than about 1 kilojoule (kJ) and equal to or less than about 2 kJ. When the intensity of the ultraviolet ray L is less than about 1 kJ, the preliminary first coating layer PCTL1 may not be sufficiently cured, and thus, the physical properties of the first coating layer CTL1 may be deteriorated. When the intensity of the ultraviolet ray L is greater than about 2 kJ, the first coating layer CTL1 may be excessively cured. As a result, cracks may occur, and the durability may be deteriorated.

An embodiment of the electronic device ED may include the first coating layer CTL1 disposed directly on the base film BFM, and an adhesive layer may not be present directly on the lower surface of the first coating layer CTL1. Accordingly, the visibility of the electronic device ED may be improved, and a total thickness of the electronic device ED may be substantially reduced. In such an embodiment, as the first coating layer CTL1 includes the fluoride resin with the waterproof properties, external moisture may be effectively prevented from entering the display module DM of the electronic device ED even though the electronic device ED is exposed to the high-temperature and high-humidity environments, and a corrosion phenomenon caused by the external moisture may be effectively prevented. In such an embodiment, as the first coating layer CTL1 includes the radical polymerization initiator, the generation of the hydrogen ions during the polymerization initiation and elongation process may be substantially reduced, and changes in physical properties of the electronic device ED may be substantially reduced.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A resin composition comprising a polymer resin, a fluoride resin, and a radical polymerization initiator, wherein the polymer resin comprises at least one selected from an epoxy siloxane-based compound, a (meth)acrylate monomer, and a tetrahydrofurfuryl acrylic acid monomer.

2. The resin composition of claim 1, wherein the polymer resin is an epoxy siloxane-based resin.

3. The resin composition of claim 1, wherein the fluoride resin comprises at least one selected from a polytetrafluoroethylene (PTFE) monomer, a polyvinylidene fluoride (PVDF) monomer, a polyvinyl fluoride (PVF) monomer, an ethylene tetra fluoro ethylene (ETFE) monomer, a polyoxymethylene (PFA) monomer, a poly[4,5-difluoro-2,2-bis(trifluoromethyl)-1,3-dioxole-co-tetrafluoroethylene] monomer, a poly[perfluoro(butenyl vinyl ether)] monomer, a poly(tetrafluoroethylene-co-2,2,4-trifluoro-5-trifluoromethoxy-1,3-dioxole) monomer, a poly(tetrafluoroethylene-co-perfluoro-3,6-dioxa-4-methyl-7-octenesulfonic acid) monomer, a fluorinated methacrylate, a fluorinated styrene, a fluorinated vinylether, a fluorinated silicon, a fluorinated imide, a fluorinated diphthalic anhydride, and a fluorinated oxetane.

4. The resin composition of claim 1, wherein a weight of the fluoride resin, relative to a total weight of the resin composition, is equal to or greater than about 10 wt. % and equal to or less than about 20 wt. %.

5. The resin composition of claim 1, wherein the radical polymerization initiator comprises at least one selected from an acetophenone-based initiator, a sulfonium salt-based initiator, and a benzophenone-based initiator.

6. The resin composition of claim 5, wherein the acetophenone-based initiator comprises at least one selected from benzyldimethyl ketal, 1-hydroxy-cyclohexyl phenyl ketone, and bis(2,4,6-trimethyl benzoyl)-phenyl phosphine oxide.

7. The resin composition of claim 1, wherein a weight of the radical polymerization initiator, relative to a total weight of the resin composition, is equal to or greater than about 1 wt. % and equal to or less than about 5 wt. %.

8. The resin composition of claim 1, further comprising a framework compound, a cross-linking agent, and a diluent,
wherein the framework compound comprises at least one selected from a polyester acrylate oligomer, an epoxy acrylate oligomer, a urethane acrylate oligomer, and a polyethylene glycol acrylate oligomer, and
the cross-link agent comprises at least one selected from tripropylene glycol diacrylate (TPGDA), hexanediol diacrylate (HDDA), dodecanedioic acid (DDDA), and bisphenol A (ethoxylate), diacrylate (BPA(EO)ₓ DA), wherein x is an integer equal to or greater than 3 and equal to or less than 30.

9. The resin composition of claim 8, wherein the diluent comprises at least one selected from a polyester acrylate oligomer and a polyether acrylate oligomer.

10. The resin composition of claim 1, wherein a viscosity of the resin composition at 25° C., which is measured by JIS K7117-2, is equal to or greater than about 1 cP and equal to or less than about 1000 cP.

11. An electronic device comprising:
a housing;
a display panel disposed in the housing; and
a first coating layer disposed on the display panel,
wherein the first coating layer comprises a resin composition comprising a polymer resin, a fluoride resin, and a radical polymerization initiator, and
wherein the polymer resin comprises at least one selected from an epoxy siloxane-based compound, a (meth)acrylate monomer, and a tetrahydrofurfuryl acrylic acid monomer.

12. The electronic device of claim 11, wherein the first coating layer has a thickness equal to or greater than about 100 micrometers and equal to or less than about 300 micrometers.

13. The electronic device of claim 11, further comprising a second coating layer disposed on the first coating layer.

14. The electronic device of claim 13, wherein the second coating layer has a hardness greater than a hardness of the first coating layer.

15. The electronic device of claim 13, wherein the second coating layer has a thickness equal to or greater than about 10 micrometers and equal to or less than about 15 micrometers.

16. The electronic device of claim 11, further comprising a polarizing plate disposed between the display panel and the first coating layer.

17. The electronic device of claim 11, further comprising a polarizing plate disposed on the first coating layer.

18. A method of manufacturing an electronic device, the method comprising:
forming a resin composition comprising a polymer resin, a fluoride resin, and a radical polymerization initiator, wherein the polymer resin comprises at least one selected from an epoxy siloxane-based compound, a (meth)acrylate monomer, and a tetrahydrofurfuryl acrylic acid monomer;
spraying the resin composition on a base substrate to form a preliminary first coating layer; and
radiating an ultraviolet ray to the preliminary first coating layer to form a first coating layer.

19. The method of claim 18, wherein
the fluoride resin comprises at least one selected from a polytetrafluoroethylene (PTFE) monomer, a polyvinylidene fluoride (PVDF) monomer, a polyvinyl fluoride (PVF) monomer, an ethylene tetra fluoro ethylene (ETFE) monomer, a polyoxymethylene (PFA) monomer, a poly[4,5-difluoro-2,2-bis(trifluoromethyl)-1,3-dioxole-co-tetrafluoroethylene] monomer, a poly[perfluoro(butenyl vinyl ether)] monomer, a poly(tetrafluoroethylene-co-2,2,4-trifluoro-5-trifluoromethoxy-1,3-dioxole) monomer, a poly(tetrafluoroethylene-co-perfluoro-3,6-dioxa-4-methyl-7-octenesulfonic acid) monomer, a fluorinated methacrylate, a fluorinated styrene, a fluorinated vinylether, a fluorinated silicon, a fluorinated imide, a fluorinated diphthalic anhydride, and a fluorinated oxetane, and
a weight of the fluoride resin, relative to a total weight of the resin composition, is equal to or greater than about 10 wt. % and equal to or less than about 20 wt. %.

20. The method of claim 18, wherein
the radical polymerization initiator comprises at least one selected from an acetophenone-based initiator, a sulfonium salt-based initiator, and a benzophenone-based initiator, and
a weight of the radical polymerization initiator, relative to a total weight of the resin composition, is equal to or greater than about 1 wt. % and equal to or less than about 5 wt. %.
